(19) United States
(12) Patent Application Publication
(10) Pub. No.: US 2018/0012246 A1
(43) Pub. Date: Jan. 11, 2018

(54) Method of Selectively Displaying Electronic Coupons In Real Time Depending On Market Conditions

(71) Applicant: Ali Kamarei, San Jose, CA (US)

(72) Inventor: Ali Kamarei, San Jose, CA (US)

(21) Appl. No.: 15/206,218

(22) Filed: Jul. 8, 2016

(51) Int. Cl. G06Q 30/02

(52) U.S. Cl. CPC G06Q 30/0226; G06Q 30/0235; G06Q 30/0239

(57) ABSTRACT

A method of displaying an electronic coupon by a system comprises a merchant assigning a discount percentage to the regular price of a service or commodity for a customer, and assigning a particular time of the day for which the electronic coupon is displayed, wherein an electronic customer coupon is issued; wherein a merchant offering commodities or services is qualified according to the customer criteria; displaying an electronic coupon to a potential customer from a merchant qualified according to the customer criteria; means for the merchant to optionally activate and/or inactivate the electronic coupon, where upon inactivation the coupon is not displayed and upon reactivation the electronic coupon is once again displayed to the customer.

### FIELD OF THE INVENTION

The present invention generally relates to marketing and sale campaigns, and more specifically, to electronic coupon sale.

### BACKGROUND OF THE INVENTION

The electronic issuance of coupons by merchants is well known. In particular companies such as Groupon and others allow merchants to generate electronic coupons to be displayed and purchased by consumers. Some of these coupons are in the form of “discounted money” in that a purchase is made of a regular price service or commodity at a lower amount. For example, if a customer gets a credit or voucher of $25 for a coupon purchased at $20, he would be receiving a discount of 20%.

Nevertheless, a problem that merchants face is their inability to market to new customers and repeat customers differently. Some merchants wish to give new customers a different percentage discount than repeat customers. Some merchants wish to give a higher percentage discount to new customers than to repeat customers. This is because they wish to give deeper discounts to new customers in order to turn them into customers, while giving a lower discount to repeat customers in order to keep them coming back. Other businesses who primarily cater to tourists may wish to give new customers a lower discount percentage and give higher discounts to local customers in order to reward repeat visits by their local customers. A tourist seeing a deeper discount for a repeat customer will most likely opt for the deeper discount than the lower discount coupon meant for a new customer. Of course, the display of both coupons that can be seen by both new and repeat customers leads to possible resentment and confusion by the general public, and customer satisfaction may diminish because of perceived different treatment. Further, a customer will naturally only select the higher percentage discount without regard to whether it is a new customer coupon or a repeat customer coupon, rendering the lower discount coupon ineffective. Thus, a smarter system and method of selectively displaying coupons is desired.

Another problem merchants face is that while electronic coupons have an expiration date, they are not directed to particular times in a day, therefore, merchants are faced with having to serve customers using discounts at times when they are the busiest, often at the expense of loosing full paying customers. Moreover, restaurants that are full may wish to inactivate and reactivate coupon offering depending on real time market conditions. If they are busy, they may wish to inactivate the coupon offering and when things slow down, they may wish to reactivate the coupon offering.

### OBJECT OF THE INVENTION

Accordingly, it is an object of this invention to provide a method and system that allows a business to selectively display or distribute coupons based on customer statuses and/or criteria.

It is an object of the invention to provide a method and system for a merchant to register with the system.

It is an object of the invention to provide a method and system for a merchant to input his or her service or commodity offerings.

It is an object of the invention to provide a method and system for a merchant to input his or her coupon offerings, and coupon requirements such as Start date, End/Expiration date, total number of coupons, time period within a day when the coupon is offered, days of a week when the coupon is offered, etc.

It is an object of this invention to provide a method and system for a merchant to easily assign different discount percentages to different targeted customer groups.

It is yet another object of the invention to provide a method and system for a merchant to activate and inactivate a coupon to correspond to real-time market (supple-demand) conditions.

It is another object of the invention to provide a method and system for the merchant to direct coupons to particular times in the day.

It is an object of this invention to provide a method and system for new customers to register.

It is an object of the invention to provide a method and system for a customer to select coupons based on his or her interests and/or preferences.

### SUMMARY OF INVENTION

A method of display of an electronic coupon by a system comprises a merchant assigning a discount percentage to the regular price of a service or commodity for a potential customer, and assigning a particular time of the day for which the electronic coupon is displayed, wherein an electronic customer coupon is issued; wherein a merchant offering commodities or services is qualified according to a customer criteria; displaying an electronic coupon to a potential customer from a merchant qualified according to the customer criteria; and means for the merchant to optionally activate and/or inactivate the electronic coupon, where upon inactivation the coupon is not displayed and upon reactivation the electronic coupon is once again displayed to the potential customer.

In one implementation, the method and system allow a merchant to select a date range wherein the electronic coupon is displayed.

In another implementation, the method and system allow a merchant to select the days wherein the coupon is displayed.

In another embodiment, the method and system further comprise a method of simultaneous display by the system, a new customer coupon and a repeat customer coupon to potential customers based upon their status as a new customer or repeat customer, that comprises the merchant assigning a primary discount percentage to the regular price of a service or commodity for a new customer, wherein an electronic new customer coupon is issued; the merchant optionally assigning a secondary discount percentage to the regular price of a service or commodity for a repeat customer, wherein an electronic repeat customer coupon is issued; a customer logging in to the system for which they had previously registered with, wherein the customer is associated with at least one customer criteria, wherein a merchant offering commodities or services is qualified according to the customer criteria; determination of whether the customer had previously purchased a coupon from the merchant offering coupons; and displaying a new customer coupon or a repeat customer coupon from a qualified merchant based on whether the customer had previously purchased a commodity or service from the qualified merchant through the system.

In one implementation of this invention, the system displays coupons from different merchants.

In another implementation of this invention, the primary discount percentage and secondary discount percentage is optionally different from each other. Furthermore, the primary discount percentage may be higher from the secondary primary discount percentage, or vice versa.

In another implementation of this invention, the customer's registration comprises of a mobile phone number and email address.

In another implementation of this invention, the customer criteria comprise distance between customer and merchant, type of merchant, satisfaction rating of the merchant, price of commodity or service, or cuisine, etc.

In yet another implementation of this invention, the qualification of a merchant is based upon one or more of the customer criteria.

In yet another embodiment the merchant can deactivate the new customer coupon and repeat customer coupon prior to their expiration in order to prevent display of the coupon to potential customers.

In another embodiment the merchant can re-activate the new customer coupon and repeat customer coupon after having deactivated the coupons and prior to their expiration, in order to display the coupons to potential customers.

### BRIEF DESCRIPTION OF THE DRAWINGS

These and other features and advantages of the invention will not be described with reference to the drawings of certain preferred embodiments, which are intended to illustrate and not to limit the invention, and in which

FIG. 1 shows a high level view of the current invention's system and components.

FIG. 2 is a flowchart of the merchant registration and coupon offering setup processes.

FIG. 3 is an exemplary user interface for a merchant's coupon offering setup.

FIG. 4 is a flowchart of the customer registration and preference input processes.

FIG. 5 is a flowchart of the customer login and coupon selection and purchase processes.

FIG. 6 is an exemplary user interface for displaying queried and filtered coupons for a customer to select and purchase.

FIG. 7 is a flowchart of the process wherein a merchant can deactivate a launched coupon sale campaign.

FIG. 8 is an exemplary user interface for a merchant to select a date range, days, and time range for display of a coupon.

FIG. 9 is an exemplary user interface for a merchant to view detailed information of an active coupon and its status, and to have the ability to deactivate the coupon.

FIG. 10 is an exemplary user interface for a merchant to view detailed information of a deactivated or expired coupon and its status, and to have the ability to activate or re-activate the coupon.

FIG. 11 is a high level view of a computer system on which an embodiment of the current invention is installed and operates.

### DETAILED DESCRIPTION OF THE INVENTION

Some embodiments are described in detail with reference to the related drawings. Additional embodiments, features, and/or advantages will become apparent from the ensuing description or may be learned by practicing the invention. The following description is not to be taken in a limiting sense, but is made merely for the purpose of describing the general principles of the invention. The steps described herein for performing methods form one embodiment of the invention, and, unless otherwise indicated, not all of the steps must necessarily be performed to practice the invention, nor must the steps necessarily be performed in the order listed. It should be noted that references to “an” or “one” or “some” embodiment(s) in this disclosure are not necessarily to the same embodiment, and such references mean at least one.

The present invention has been conceived with the aim of addressing one or more of the current electronic coupon sale problems. More specifically, the present invention is directed to a computer system and method that allows merchants to offer coupons to selective customer groups.

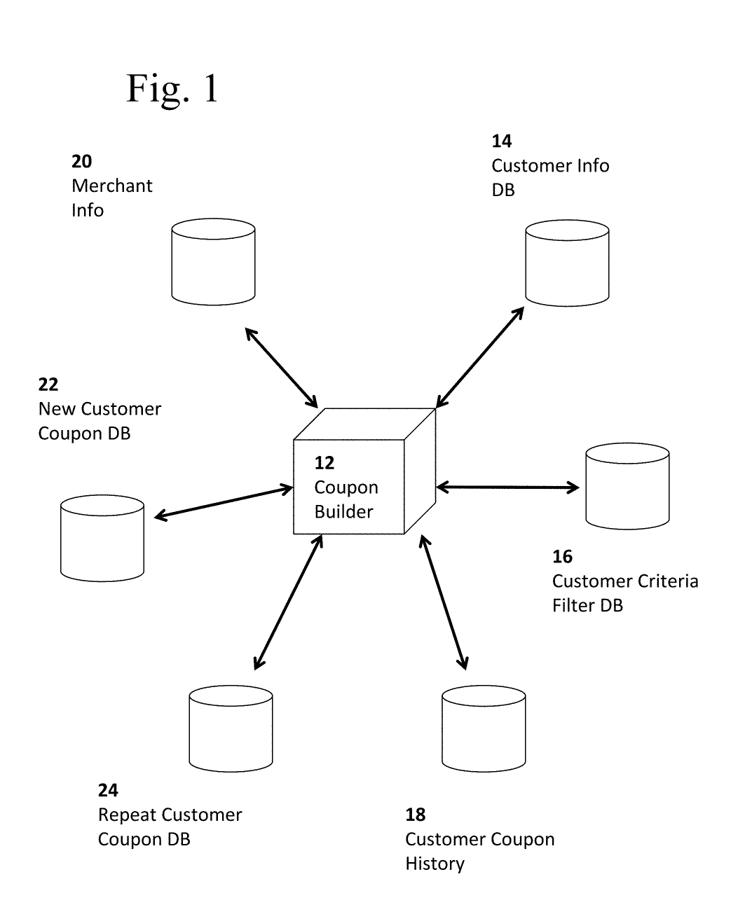

Referring to FIG. 1, a high level view of the current invention is shown. At the center of the system is a Coupon Builder component 12 where a proprietary business intelligence algorithm resides. Coupon Builder component interfaces with and/or manages Customer Info database 14, Customer Criteria Filter database 16, Customer Coupon History 18, Merchant Info database 20, New Customer Coupon database 22, and Repeat Customer Coupon database 24. It is appreciated that, in different implementations of the current invention, one or more of these databases may be merged in one database, and, perhaps, each database may be implemented as a database table.

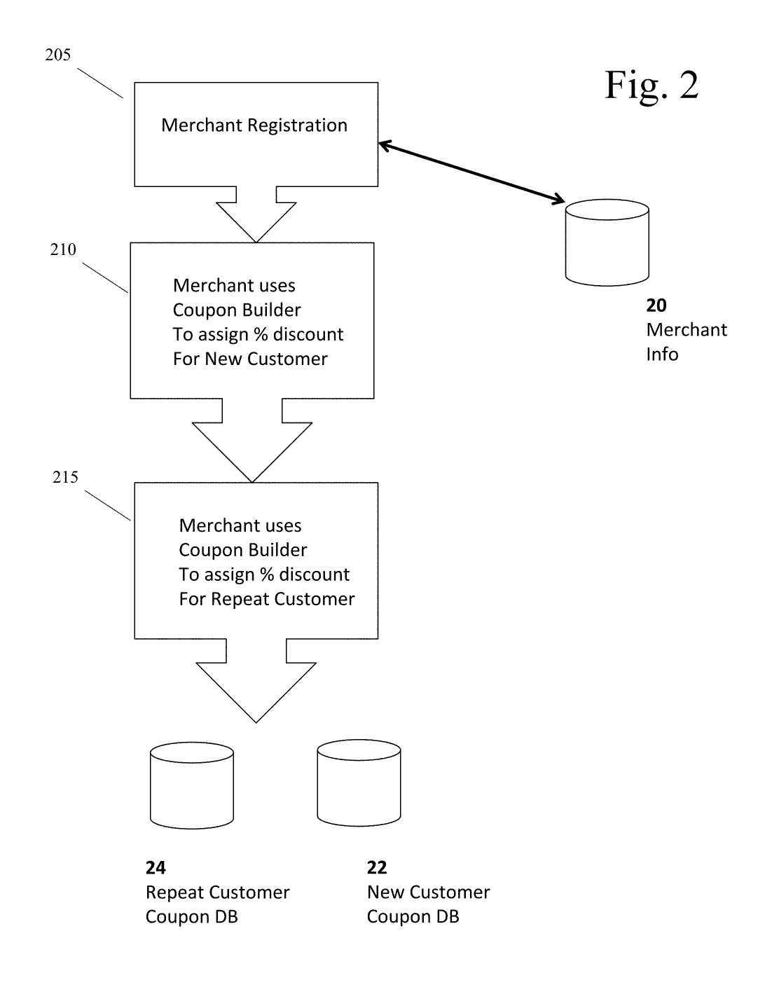

Referring to FIG. 2, in one embodiment, a detailed merchant interface is shown. A merchant is greeted by the system's Merchant Registration component 205. The merchant enters business information, such as business name, contact person and contact information, product offerings and, especially, the current promotional product. The Merchant Registration component 205 takes in these information, generates a unique merchant Id for the merchant, and saves these information in the Merchant Info database 20 under the unique merchant Id. While the merchant's session is active, the merchant is seamlessly moved to Coupon Builder component's coupon creation and assignment component 210 where the merchant enters the promotional product, regular price, and the promotional discount percentage. The merchant can optionally assign a different promotional discount percentage for repeat customers using the component 215 of the Coupon Builder component. Coupon Builder immediately saves these information to a New Customer Coupon database 22, and a Repeat Customer Coupon database 24. It is appreciated that in another embodiment of the current invention these two coupon databases can be merged in one database, or even one database table, that employs a status flag to mark coupons for new or repeat customers.

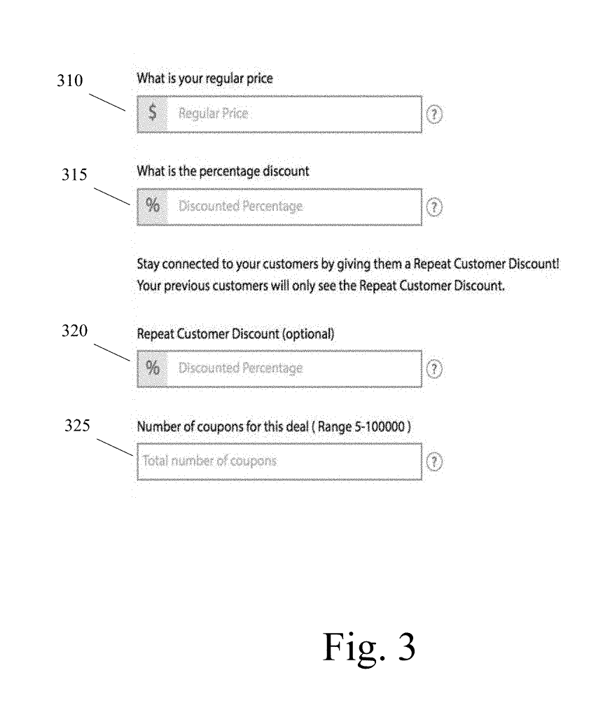

Referring to FIG. 3, an exemplary coupon creation and assignment interface is shown. The interface allows a merchant to enter its promotional product's regular price into the textbox 310. Next, the merchant can enter the discount percentage, i.e., 10%, 12%, etc., for the current promotion in the textbox 315. Next, the merchant can optionally enter a different discount percentage for repeat customers into the textbox 320. This different discount percentage can be optionally higher or lower than the first-timer discount above. The merchant can optionally enter the max number of coupons to be created for this promotion into the textbox 325.

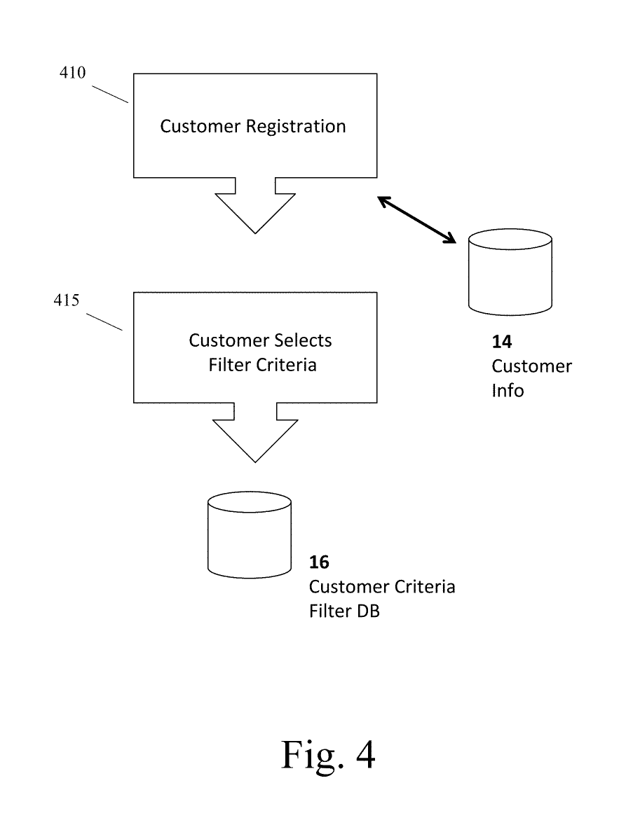

Referring to FIG. 4, in an optional embodiment, a customer registration interface is shown. Using the Customer Registration component 410, a customer can register with the system so that the system can intelligently assist the customer in future display of repeat and/or new customer coupons. The customer just needs to enter one required piece of information for registration: preferably a mobile number if for example access to coupons is via a mobile phone. The mobile number is used for the customer's identification. A user ID and password are also created and entered; they are used for convenient future logins and purchases. Other information such as email, name and mailing address are optional, or they can be obtained from the customer's online payment or other service providers such as Facebook account. Registration information is saved to the Customer Info database 14. After entering personal information, the customer can optionally select purchase-related factors and information using the Criteria Filter component 415. This component helps the customer define his or her interests and preferences, such as types of products/services, types of merchants, minimum merchant's customer satisfaction rating, price ranges of the products/services, and distance from the customer's location. It is understood that other criteria may be incorporated by the system such as ambiance and environmental and surrounding conditions of the business. When the customer finishes selecting the criteria to define the preference filter, the criteria are saved to the Customer Criteria Filter on their mobile device. The Criteria Filter component also executes a proprietary algorithm that retrieves and filters coupons from the New Customer Coupon database 22, and displays the filtered coupons for the customer to select and purchase. In another embodiment, the system optionally allows a customer to also view and filter coupons by Customer Criteria selected on the customer's mobile device with or without registration. It is understood that the customer may modify a previous Customer Criteria on their mobile device at any time.

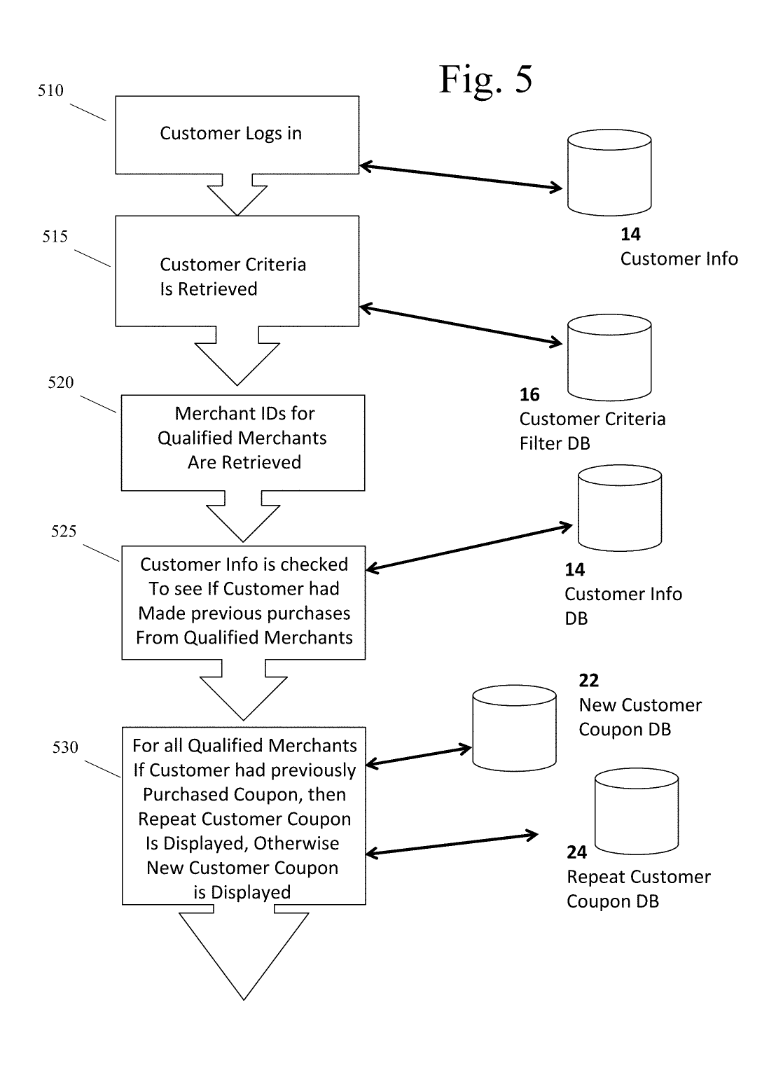

Referring to FIG. 5, in one embodiment, a detailed coupon purchase process is shown. A customer is greeted by the Customer Login component 510. This component verifies the entered user Id and password against the Customer Info database 14, where customer registration information has been saved by the Customer Registration component disclosed above. Upon a successful verification and authentication, the customer's saved preference filter criteria are retrieved from the Customer Criteria Filter database 16 using the user Id as a key. Preferably, filtering of coupons by Customer Criteria is selected on the customer's mobile device. Customer Filter Criteria Persistent component 515 retrieves and persists the criteria for other components' uses. Using the queried criteria, the Criteria Filter component, disclosed above, executes the proprietary algorithm that retrieves and filters coupons from the New Customer Coupon database 22 and Repeat Customer Coupon database 24 within a second. Furthermore, Merchant ID's for qualified merchants, based on product/service, distance, etc., are also retrieved by a Merchant Info component 520. With the merchant and customer information retrieved and persisted, the Criteria Filter component, in process 525, further queries the repeat customer status from the Customer Info database 14, and, then, filters the previously queried coupons further to retain only first-timer or repeat customer coupons for each key pair customer Id and merchant Id in the process 530. The final filtered result will be displayed to the customer for the customer to select and purchase.

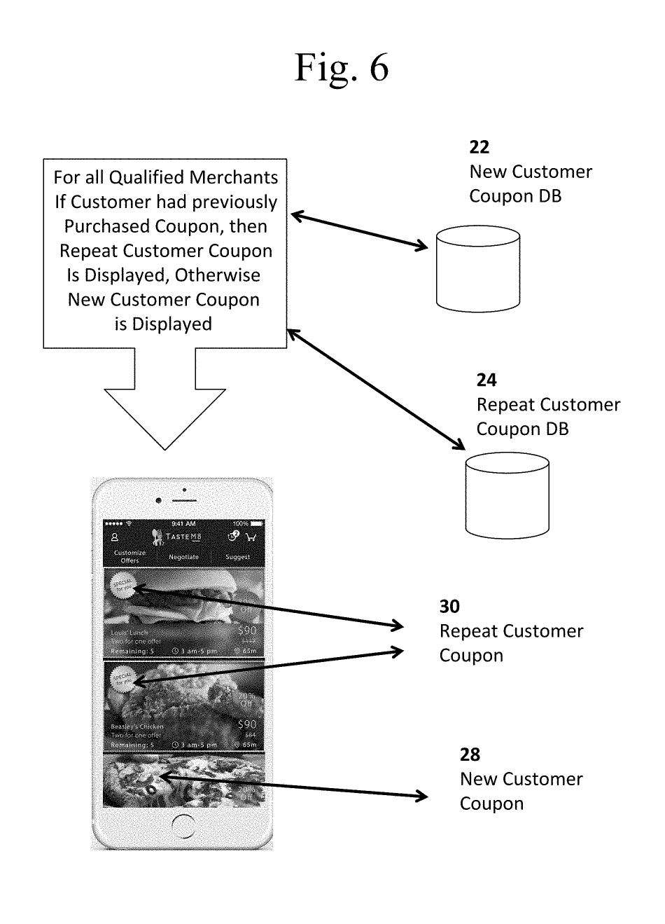

Referring to FIG. 6, in one embodiment, an exemplary user interface is shown on a mobile device. The queried and filtered coupons graphically displayed on the mobile device's screen. On the display, the customer purchased and redeemed coupons from the top two merchants, thus he or she only sees the repeat customer coupons this time. The customer will never see both first-timer and repeat customer coupons for a particular merchant at the same time on the display. For the third coupon, the customer has not purchased or redeemed a coupon with the third merchant, thus, he or she sees a first-timer coupon.

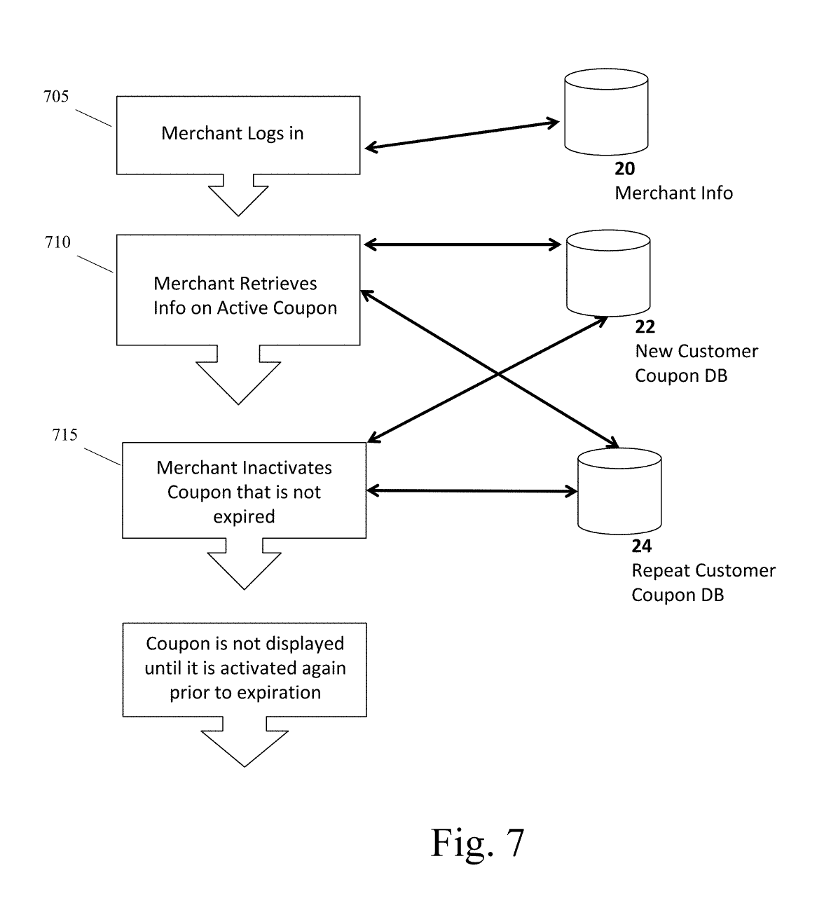

Referring to FIG. 7, in one embodiment, a merchant has total control over his or her coupon offering. As disclosed above, using the Coupon Builder component, a merchant can create a coupon sale campaign. After creating and launching the campaign, the merchant can manage the campaign online any time by logging on to the system. First, the merchant logs in the system using a Merchant Login component 705 to access an ongoing campaign. The Merchant Login component verifies the merchant's entered login information against a Merchant Info database 20. If the verification succeeds, the merchant is authenticated and taken inside the system where the merchant can retrieve his or her information as well as any coupon campaign intelligence. Next, using an Intelligent Dashboard component 710, the merchant can query the number of active coupons on the market, and, other market intelligence, such as number of coupons purchased per day, purchase to redemption time, repeat customers, etc. The Dashboard component queries from New Customer Coupon database 22 and Repeat Customer Coupon database 24 the requested information, filters and aggregates them according to proprietary algorithms and formulas, and, then, displays them in the Dashboard. Based on the market intelligence, the merchant can intelligently adjust the offerings to achieve the best marketing result. For example, if the merchant determines that he or she has reached the campaign's objectives, he or she can deactivate and stop any coupon offering before expiration of the coupon, using a Coupon Builder component 715. The Coupon Builder component will save the changes to New Customer Coupon and Repeat Customer Coupon databases. The coupon inactive status will prevent a customer from seeing the coupon, and buying it. It is appreciated that, at any time, the merchant can re-launch any inactive coupon campaign prior to the expiration of the coupon.

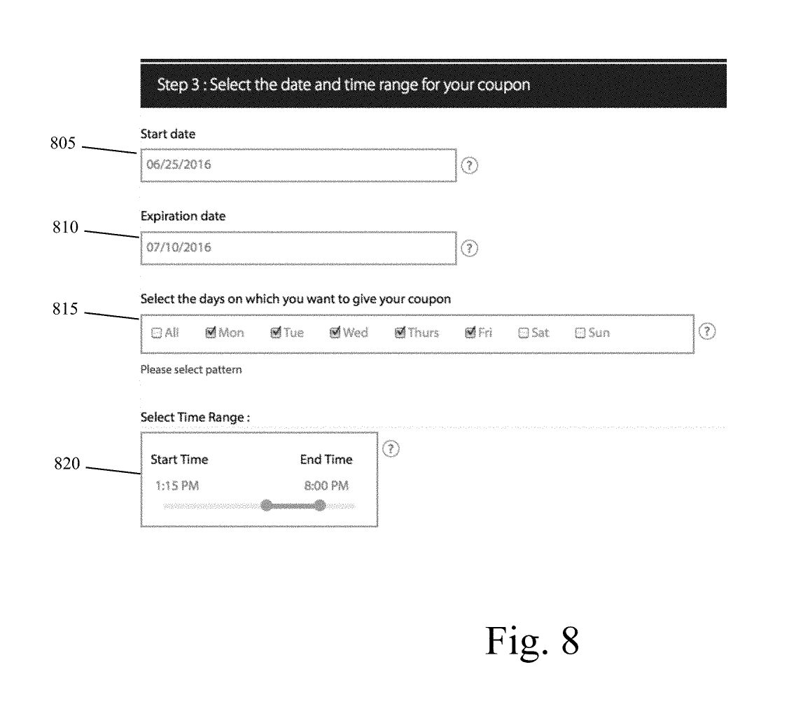

Referring to FIG. 8, in one embodiment, a merchant can select a Start date, Expiration date, days of a week, and time range of a day for a coupon offering. The merchant can enter the Start date in the textbox 805 and the Expiration date in the textbox 810. For days of a week selection, the merchant is presented with eight selection boxes: one for a convenient selection of all days of a week, and seven for each individual day of a week from Monday to Sunday. All of these selection boxes are encapsulated in a custom container component 815. After setting the date range and the week days of the coupon offering, the merchant can use the slider component 820 to set the time range of a day he or she wants to offer the coupon. As the merchant moves the slider's ends, representing the Start and End times, the times are displayed on the screen, so the merchant can be certain about the times he or she selects.

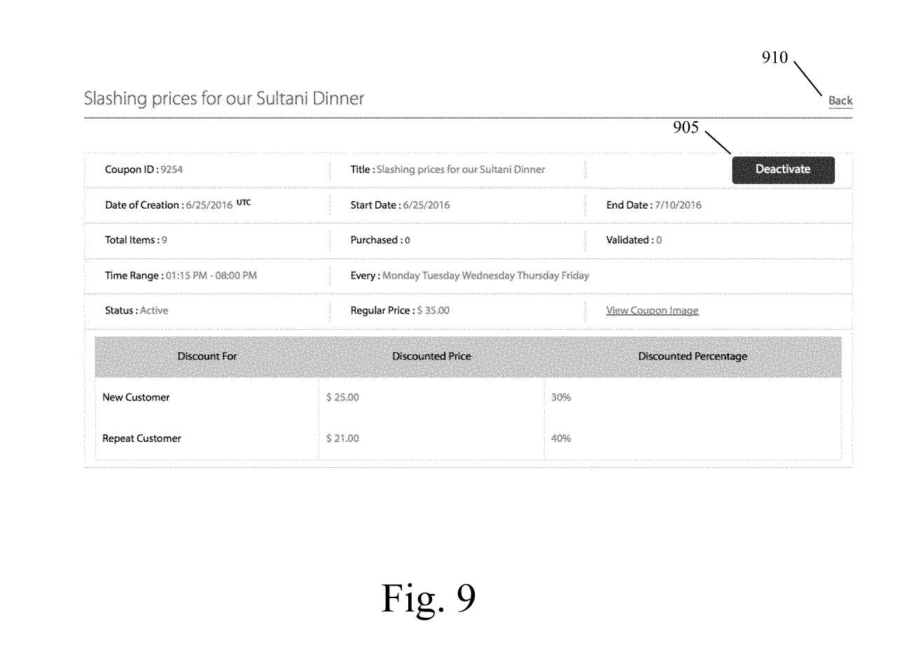

Referring to FIG. 9, a user interface of the Coupon Builder component in one embodiment is shown. From the merchant main/home page, a merchant can select a particular coupon to see more detailed information, such as Title/Name, Date of Creation, Start date, End or Expiration date, total coupons offered, number of purchased coupons so far, number of validated/used coupons, times of a day when the coupon can be seen/purchased, days of a week when the coupon can be sold, Active or Deactivate status, regular price of the on-sale product, new customer's discounted price and percentage, and repeat customer's discounted price and percentage. On this interface, command button 905, labeled “Deactivate,” is provided to the merchant so he or she can quickly deactivate a coupon in response to Demand-Supply or market conditions, and effectively implement his or her marketing strategy. The interface also provides another command button 910, labeled “Back,” that will take the merchant back to the previous page.

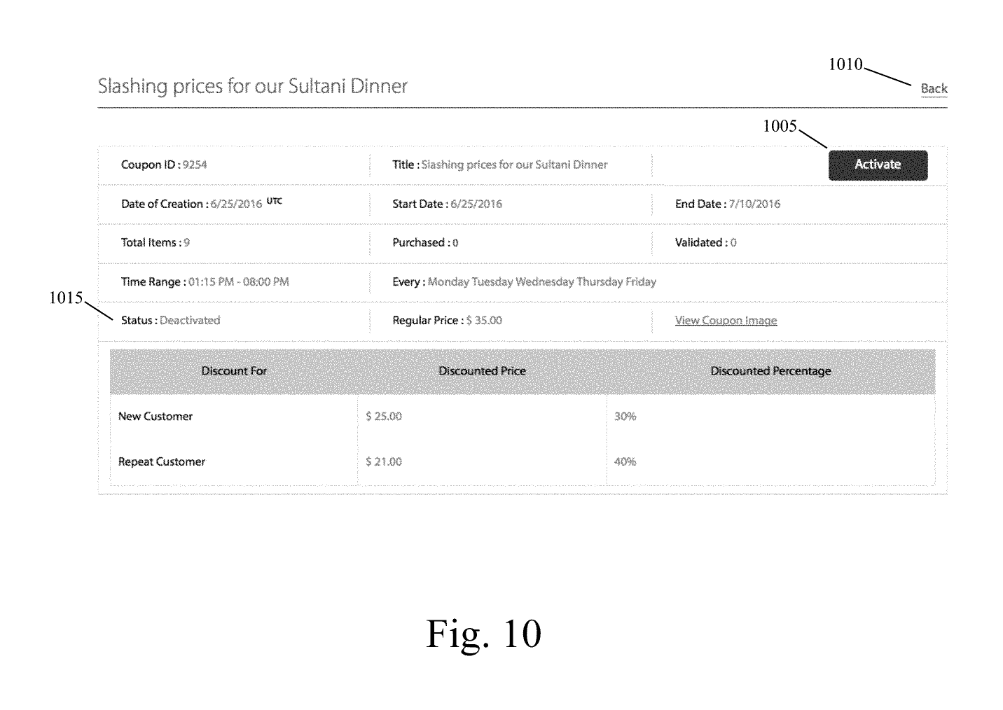

Referring to FIG. 10, a user interface in one embodiment is shown. This interface is almost identical to the user interface disclosed in FIG. 9, except the command buttons. On this interface, a command button 1005, labeled “Activate,” is provided to the merchant so he or she can activate a deactivated or expired coupon. Like the interface disclosed in FIG. 9, a Back command button 1010 is also provided so the merchant can go back to the previous page. It is appreciated that user interfaces in FIGS. 9 and 10 can be seen as two states of one dynamic user interface. That is, depending on the status of a coupon, Active or Deactivated/Expired, the Status text 1015 will display the correct status, and the system will respectively show “Deactivate” or “Activate” command button.

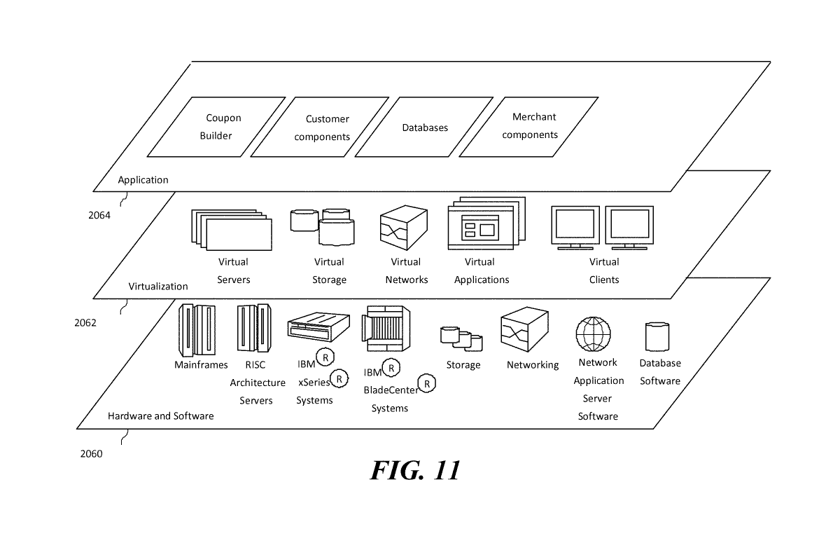

Referring now to FIG. 11, in one embodiment, the current invention's system and method executes and manages hardware and software layer 2060 includes hardware and software components. Examples of hardware components include mainframes, in one example IBM® zSeries® systems; RISC (Reduced Instruction Set Computer) architecture based servers, in one example IBM pSeries® systems; IBM xSeries® systems; IBM BladeCenter® systems; storage devices; networks and networking components. Examples of software components include network application server software, in one example IBM WebSphere® application server software; and database software, in one example IBM DB2® database software. (IBM, zSeries, pSeries, xSeries, BladeCenter, WebSphere, and DB2 are trademarks of International Business Machines Corporation registered in many jurisdictions worldwide). Furthermore, in yet another embodiment, for scaling and management, virtualization and cloud computing may be employed. Virtualization layer 2062 provides an abstraction layer from which the following examples of virtual entities may be provided: virtual servers; virtual storage; virtual networks, including virtual private networks; virtual applications and operating systems; and virtual clients. In one example, application layer 2064 may run on top of the virtualization layer and provide the functionalities disclosed above.

1. A method of display of an electronic coupon by a system, comprising:
a. a merchant assigning a discount percentage to the regular price of a service or commodity for a customer, and assigning a particular time of the day for which the electronic coupon is displayed, wherein an electronic customer coupon is issued,
b. displaying an electronic coupon to a potential customer from a merchant qualified according to a customer criteria,
d. means for the merchant to optionally activate and/or inactivate the electronic coupon, where upon inactivation the coupon is not displayed and upon reactivation the electronic coupon is once again displayed to the customer.

2. The method of claim 1, further comprising means for selecting a date range wherein the electronic coupon is displayed.

3. The method of claim 1, further comprising means for selecting the days wherein the coupon is displayed.

4. The method of claim 1 further comprising a method of simultaneous display by the system, a new customer coupon and a repeat customer coupon to potential customers based upon their status as a new customer or repeat customer, comprising:
a. the merchant assigning a primary discount percentage to the regular price of a service or commodity for a new customer, wherein an electronic new customer coupon is issued,
b. the merchant optionally assigning a secondary discount percentage to the regular price of a service or commodity for a repeat customer, wherein an electronic repeat customer coupon is issued,
c. a customer logging in to the system for which they had previously registered with, wherein the customer is associated with at least one customer criteria, wherein a merchant offering commodities or services is qualified according to the customer criteria,
d. determination of whether the customer had previously purchased a coupon from the qualified merchant offering coupons,
e. displaying a new customer coupon or a repeat customer coupon from each qualified merchant based on whether the customer had previously purchased a commodity or service from the qualified merchant through the system.

5. The method of claim 4, wherein the system displays coupons from different merchants.

6. The method of claim 4, wherein the primary discount percentage and secondary discount percentage is optionally different from each other.

7. The method of claim 4, wherein the primary discount percentage is higher from the secondary primary discount percentage.

8. The method of claim 4, wherein the primary discount percentage is lower from the secondary primary discount percentage.

9. The method of claim 4, wherein the customer's registration comprises of a mobile phone number and email address.

10. The method of claim 1, wherein the customer criteria is selected from the group comprising;
distance between customer and merchant, type of merchant, satisfaction rating of the merchant, price of commodity or service, or cuisine.

11. The method of claim 1, wherein the qualification of a merchant is based upon one or more of the customer criteria.

12. The method of claim 1, wherein the merchant can deactivate the new customer coupon and repeat customer coupon prior to their expiration, in order to prevent display of the coupon to potential customers.

13. The method of claim 1, wherein the merchant can re-activate the new customer coupon and repeat customer coupon after having deactivated the coupons and prior to their expiration, in order to display the coupons to potential customers.
